(19) United States
(12) Patent Application Publication
(10) Pub. No.: US 2012/0010859 A1
(43) Pub. Date: Jan. 12, 2012

(54) FREQUENCY PHYSICAL CARRIER FOR DIAGNOSTICS, MEDICAL THERAPY AND HUMAN, ZOOTECHNCAL AND AGRONOMIC ENHANCEMENT

(76) Inventor: Dario Maximilian SPERA, Roma (IT)

(21) Appl. No.: 13/173,328

(22) Filed: Jun. 30, 2011

(30) Foreign Application Priority Data
Jul. 8, 2010 (EP) 10425231.7

(51) Int. Cl. G06F 15/00

(52) U.S. Cl. 702/189

(57) ABSTRACT

Physical carrier wherein radiation frequencies are recorded, obtained by a process including the stages of:
a) generating biologically active radiation frequencies, which are synthesized or sensed by biologically active chemical compounds, including medicaments;
b) loading the biologically active frequencies into a computer store;
c) digital processing of said biologically active frequencies loaded into said computer store, implemented by a digital data processing programme, including programmes for processing photographs, videos, audios or texts.
d) applying an electric potential difference between a target material and said computer store of stage (c), including by putting them inside a Faraday cage under a voltage.

This invention relates to a physical carrier configured as a data store which is non-volatile (i.e. able to keep stored data and to make these ones available when it is not electrically supplied).

It is known that in medical diagnostics laboratory analyses are often carried out that require some time and at times the use becomes necessary of costly machineries not always available at the moment. Moreover, it is also known that in medical therapy and for the enhancement of human performances one makes use of chemical compounds. For zootechnical and agronomic enhancement too, such as e.g. for the storing of food, or the stimulation of the production of milk, one makes use of chemical compounds, particularly hormones and parasiticides. However, well known disadvantages and restrictions are connected to the chemical action of the latter.

This invention has the object of providing diagnostic, therapeutic means and means for human, zootechnical and agronomic enhancement that achieve the effects of biologically active chemical compounds, without the disadvantages and the restrictions of chemical action (by the expression “biologically active” those chemical compounds are meant herein that have an effect on biologic tissues, particularly those of medical, both diagnostic and therapeutic; of human enhancement interest; of zootechnical and agronomic usefulness).

The studies are known of Nobel Prize for Medicine Luc Montagnier who has put into evidence that in living organisms the appearance of specific diseases corresponds to specific deformations of the electromagnetic structure of the organism and that there are electromagnetic signals specific for each disease.

International Application No. WO 94/17406, having the title “PROCEDE ET DISPOSITIF DE TRASMISSION SOUS FORME DE SIGNAL DE L'ACTIVITE BIOLOGIQUE D'UNE MATIERE PORTEUSE A UNE AUTRE MATIERE PORTEUSE, ET DE TRAITEMENT D'UN TEL SIGNAL, ET PRODUIT OBTENU AVEC UN TEL PROCEDE” (Inventor Jacques BENVENISTE), discloses a method and a device used to transmit the biological activity of a first matter said the carrier to a second matter said the target. The method consists in exposing the biological activity carrier to a detector of electromagnetic signals; amplifying the emitted electromagnetic signals characteristic of the manifestation of the biological activity and thereafter exposing the target to an electromagnetic signal emitter connected to the detector through a transmission and amplification circuit, in order to transmit the signal characteristic of the biological activity of the target.

International Application No. WO 94/17637, having the title “PROCEDE ET SYSTEME POUR PRODUIRE UNE SUBSTANCE OU UN SIGNAL AYANT UN EFFET COAGULANT OU ANTICOAGULANT” (inventors Jacques BENVENISTE and Didier GUILLONNET), discloses a method and a system for recording and digitizing an electrical signal characteristic of a molecule possessing a biological activity, after analogue-to-digital conversion by the aid of a computer.

International Application No. WO 2007/068831, having the title “METHOD FOR CHARACTERISING A BIOLOGICALLY ACTIVE BIOCHEMICAL ELEMENT BY ANALYSING LOW FREQUENCY ELECTROMAGNETIC SIGNALS” (inventor Luc MONTAGNIER), discloses a method for characterizing a biologically active biochemical element through the analysis of low frequency electromagnetic signals emitted by a sample of analyzable material.

International Application No. WO 2007/147982, having the title “METHOD OF DETECTING MICROORGANISMS WITHIN A SPECIMEN” (inventors Luc MONTAGNIER and Aissa JAMAL), discloses a method for the diagnostic detection of microorganisms through the frequencies of the latter.

Therefore, this invention reaches the object above by exploiting the action of the electromagnetic frequencies of biologically active chemical compounds. The frequencies are recorded i.e. downloaded in a physical carrier capable of keeping them in a non-volatile way, i.e. without needing for a supply of electric power, and of re-emitting them coming in contact with another material carrier because of potential difference with respect to the latter. The other material carrier may be human skin.

Therefore, it is the subject-matter of this invention a computer store wherein radiation frequencies are downloaded i.e. recorded, obtained by the following process:

a) generating biologically active radiation frequencies, including electromagnetic radiation frequencies, including optical radiation, and including mechanical radiation frequencies, including acoustic radiation, which frequencies are synthesized or sensed by biologically active chemical compounds, including medicaments; hormones, including prolactin; parasiticides; antiseptics;

b) loading said biologically active frequencies into a computer store; including a solid-state microelectronic circuit or microchip; a magnetic store; an optical store; a holographic store;

c) digital processing of said biologically active frequencies loaded into said computer store, implemented by a digital data processing programme, including programmes for processing photographs, videos, audios or texts.

It is also the subject matter of this invention a physical carrier wherein radiation frequencies are downloaded from such computer store carrying useful frequencies by applying an electric potential difference therebetween, including by putting them inside a Faraday cage under a voltage.

Particularly the physical carrier may be composed of a plastic material, including polyethylene (PE); polyethylene terephthalate (PET); polypropylene (PP); polyvinylchloride (PVC); polyvinyl methacrylate (PVMA); polymethyl methacrylate (PMMA); polyamide (PA) or Nylon; polyetherketone (PEK); polytetrafluoroethylene (PTFE); polycarbonate (PC) or polyesters of carbonic acid; and copolymers thereof; particularly, in the shape of a film, including a strip.

Further, in particular the physical carrier may be composed of an elastomer, including polybutadiene rubber (PER); natural rubber (NR) i.e. 1-4 polyisoprene; chloroprene rubber (CR) i.e. polychloroprene; silicone rubbers, including methylvinylpolysiloxane (VMO); fluoroelastomers and copolymers thereof; particularly, in the shape of a film, including a strip.

Still further in particular, the physical carrier may be composed of a siliceous material, including quartz; quartz glass; glass; lead glass; steatite; calcareous rock, including travertine silicate; natural and synthetic crystals and stones.

Still further in particular, the physical carrier may be in the shape of a grid.

This invention will be understood based on the following exemplifying disclosure, absolutely not restrictive thereof, having reference to specific embodiments thereof.

The process for obtaining a frequency carrier of this invention includes the following stages.

The first stage is to determine useful frequencies, i.e. the frequencies of interest for the purposes of this invention.

The frequencies useful for the inventive purposes may be the electromagnetic frequencies emitted by medicaments as can be senses through an apparatus for sensing electromagnetic frequencies, such as e.g. apparatus “Vega-Test”. This one is an electromedical apparatus comprising a Wheatstone bridge circuit containing a galvanometer having a reading dial, a direct current source and a metal honeycomb casket in which medicaments may be inserted in series to the circuit. “Vega-Test” apparatus is capable of recording the electromagnetic frequencies of substances in general, and of medicaments in particular, through a process of analogue-to-digital conversion, of saving these ones in a store and subsequently of re-emitting them re-transforming them into electromagnetic signals through a digital-to-analogue conversion process. The apparatus is intended to be used in cooperation with an electrode, which a patient keeps in his/her hand, and a tip which is put in contact with the skin of the patient, at an elective point, so a patient-apparatus circuit being closed. Having inserted a determined substance in the apparatus, the response is read on the dial to the substance and to the characteristic frequency of the substance.

The electromagnetic frequencies e.g. of a medicament may also be sensed by means of a high resolution camera, possibly also sensible to infrared and ultraviolet radiation.

The frequencies useful for the inventive purposes may be obtained with synthesizers. The frequencies suitable for determining a therapeutic or human enhancement effect are determined based on experimental tests, evaluating the response of human subjects to inventive carriers that have data recorded therein obtained starting from determined frequencies. In particular one may evaluate the responses to specific kinesiologic tests, or tests on the stabilometric platform (stabilometric platforms are well-known apparatuses for sensing the body balance performances of a person and many other data, such as blood pressure, heartbeat etc.) to evaluate the betterment of equilibrium. For instance, a test may be carried out with a dynamometer evaluating how many kilograms and for how much time a human subject is able to push or to pull when applying the frequencies thereto.

The second stage is to load the found useful frequencies in a computer store.

The third stage is a digital processing of the frequencies loaded in the computer store through a software programme. The frequencies emitted by the store are adjusted experimentally to match the useful ones.

The store may be put in contact with the skin of a person at elective points. A potential difference arises between the skin and the store, making the latter to emit the frequencies. The adjustment is carried out putting the store in contact with the skin at elective points, where the potential difference is high, so that the store carrying the frequencies turns out to be highly effective.

It is envisaged according to this invention that the digital processing of the frequencies may be carried out with a programme for rendering input data into image format data. Photograph management and processing programmes may be used, such as e.g. Adobe Photoshop. In particular, through the function “Transparency” of such programmes it is possible to ‘dilute’ i.e. to partialize the effect of the electromagnetic frequencies on the human body. For instance, in case the frequencies are the electromagnetic frequencies of a medicament, it is so possible with the inventive carrier to emulate the administration of half a tablet of the medicament.

The digital processing of the frequencies may, on the other hand, be carried out with a processing programme in video, audio or text format, and more generally with any suitable digital processing programme.

The frequencies are impressed in the carrier material putting the computer store, particularly a store microchip, carrying the useful frequencies on the material in the Faraday cage, closing the cage and applying a useful potential difference (not to the ground) to the Faraday cage for a useful time.

The inventive carrier may be a solid state microelectronic circuit i.e. a microchip.

The loading and the digital processing of the frequencies creates a bitmap in the microchip, featuring a specific pattern of the flow of the electrons in the microchip. The microchip may be for instance a Micro SD by Secur Digital.

So, the useful frequencies having an interest for the inventive objects may be sensed or else found de novo by a procedure wherein the frequencies are generated and experimentally tested as regards their effects. According to a procedure, it is envisaged to test frequencies, adjusted by known means, such as e.g. a rheostat, on a person on a stabilometric platform, or an electronic dynamometer. The frequencies may be electromagnetic or mechanical, e.g. impressed in a Faraday cage (electromagnetic radiation case) or emitted by sound diffusers (mechanical radiation case).

In the test the frequencies are adjusted till the sensed biometric data are the desired ones. When the person is on the stabilometric platform or has the dynamometer applied thereto, one sees the differences of the effect of the medicament on the person and based on biometric variations one tries to replicate the effect with the medicament in contact with the skin in correspondence with elective points of the body. One measures the biometric variations and carries out an adjustment. In the case disclosed of a store microchip, so one modifies a bitmap configuration therein to achieve the same effect with the microchip.

To obtain a bitmap we start with a known frequency. We obtain the biometric data of a person under the effects of a frequency. These data are to be reproduced by means of the bitmap. This one is modified so as to obtain the same results, by virtue of the aforesaid program.

Based on the frequency emitted on the human subject under test by a medicament there is a variation of performance of the human subject. The best frequency is that which gives the best results in the sense clarified above, and it is this frequency that will be replicated.

So biometric data are sensed of the person who is the subject under test. Referring to a store microchip embodiment of the invention, for instance a flash memory, one works on a file that has to be stored in the flash-memory according to such data.

The microchip is applied at the elective points of the body and connected through a cable to a computer by two pins for power supply and two pins for data supply and reading. In this way one modifies said bitmap of the microchip and senses the biometric results by a rheostat.

The bitmaps produced are readable by the programme Adobe Photoshop which sees a nearly black image. It transforms the bitmap, like other programmes for photographic images, it renders the bitmap more or less transparent and the algorithm allows to dilute the effect of the bitmap.

Impedance measurement of a biologic tissue provides other data to produce a more precise bitmap. Where there is an inflammation, a greater passage of ions is needed to have a curative effect. The bitmap is modified so that there is a lowering of the impedance of the tissue, in real time.

Based on the tests conducted on a person one modifies and upgrades the data in such a way that the bitmap that is generated when the data are downloaded in the store is able to produce the same useful frequency when put in contact with human skin. Based on the potential difference of the skin the electronic elements of the chip are excited, generating a frequency having a useful effect.

So, in accordance with the results of the frequency tests using a dedicated software, we create a bitmap in a microchip.

This one is thereafter suitable to be applied on the human skin re-emitting the frequencies under the bioelectric potential difference impressed thereto, existing with respect to the skin. Without willing to be tied to any theory, it is thought that by applying the microchip on the skin, it develops under the impressed potential difference of the skin a flow of electrons in the electronic elements of the microchip so that waves are excited and come to generate a carrying wave. To generate a useful wave one has to store the data in the form of a bitmap inside the store, so that the bitmap becomes like a circuit for the electrons and this flow of electrons modifies the carrying frequency into a useful frequency.

In the medical literature points are known, named ‘trigger points’ in which the potential difference is a maximum so that the frequencies one wants to develop are stronger are more efficient. The trigger points are utilized as points where to apply the microchip.

The inventive carrier may also be any store medium allowing the passage of frequencies onto any useful material, such as a magnetic store, an optical store, a holographic store.

Moreover, the inventive carrier may be composed of a plastic material, such as polyethylene (PE); polyethylene terephthalate (PET); polypropylene (PP); polyvinylchloride (PVC); polyvinyl methacrylate (PVMA); polymethyl methacrylate (PMMA); polyamide (PA) or Nylon; polyether ketone (PEK); polytetrafluoroethylene (PTFE); polycarbonate (PC) or polyesters of carbonic acid; and copolymers thereof.

The inventive carrier still further may be composed of an elastomer, such as polybutadiene rubber (PBR); natural rubber (NR) i.e. 1-4 polyisoprene; chloroprene rubber (CR) i.e. polychloroprene; silicone rubbers, such as methyl vinyl polysiloxane (VMO); fluoro elastomers and copolymers thereof.

The inventive carrier composed of a plastic material or an elastomer may be in the shape of a film, in particular a strip. This one may be in particular in the shape of a bracelet. The strip of useful material may be ‘activated’ by impressing the same with the frequencies in digital format also downloading the same thereinto from a microchip. The useful material of the strip may be selected among those which are retentive enough not to lose the impressed i.e. recorded frequencies. So, for instance, a strip may be stored in a container without deactivating. The frequencies may only be removed from a strip through erasing, for instance to impress the strip with new frequencies. The frequency passage from the microchip to the useful material takes place through materials conducting said frequencies such as silicates and water. The frequencies are impressed by arranging the useful materials inside a Faraday cage put under voltage, so the frequencies amplified, these ones can be impressed in all of the material arranged inside the cage.

The inventive carrier may also be composed of a siliceous material i.e. a material substantially composed of silicates, such as quartz; quartz glass; glass (substantially composed of sodium and calcium silicate); lead glass (substantially composed of siliceous glass containing lead oxide in addition to potassium and sodium oxides); steatite (a rock substantially composed of hydrated magnesium silicate); calcareous rock, including travertine silicate; natural and synthetic crystals and stones.

More generally, the inventive carrier may be composed of any material useful for recording and emitting frequencies downloaded therein.

Putting the inventive carrier in physical contact with the epidermis of a human subject at elective points an electric potential difference is determined between the carrier and the epidermis, that activates the emission of electromagnetic frequencies on the part of the carrier itself.

The electromagnetic frequencies emitted by the inventive carrier act on the body of the subject performing a therapeutic action (like a chemical medicament) or an action of performance enhancement. For instance, with the inventive carrier it is possible to better the postural equilibrium of the body substantially.

It is also envisaged that the inventive carrier is realized in the shape of a grid wherein electromagnetic frequencies of parasiticides have been downloaded. Such a grid arranged in a water stream is suitable for conditioning the water itself with the frequencies of the parasiticides, with benefit for the cattle which will take such frequencies by drinking the water.

Analogously an inventive carrier may have the frequency of prolactin recorded therein to stimulate the production of milk.

This invention has been disclosed having reference to exemplifying embodiments thereof, but variations may be made thereto without departing from the scope of protection thereof, which only is defined by the appended claims.

### BIBLIOGRAPHY

F. A. Popp et al., “Electromagnetic Bio-Information”, Urban & Schwarzenberg Verlag, 1989;
H. W. Schimmel et al., “Short Manual of the Vega Test Method Bioenergetic Regulatory Technique”, Vega Grieshaber, Schiltach, 1981;
H. W. Schimmel et al., “Manuale del Metodo Vega-test”, Ed. Named;
Luc Montagnier, Convention on “Integration between physics, chemistry and biology at the basis of the medicine of the future”, held in Milan on 30 Sep., 2009

1. Computer store wherein radiation frequencies are downloaded i.e. recorded, obtained by the following process:
a) generating biologically active radiation frequencies, including electromagnetic radiation frequencies, including optical radiation, and including mechanical radiation frequencies, including acoustic radiation, which frequencies are synthesized or sensed by biologically active chemical compounds, including medicaments; hormones, including prolactin; parasiticides; antiseptics;
b) loading said biologically active frequencies into a computer store; including a solid-state microelectronic circuit or microchip; a magnetic store; an optical store; a holographic store;
c) digital processing of said biologically active frequencies loaded into said computer store, implemented by a digital data processing programme, including programmes for processing photographs, videos, audios or texts.

2. Physical carrier wherein radiation frequencies are downloaded from the computer store carrying useful frequencies of claim 1 by applying an electric potential difference therebetween, including by putting them inside a Faraday cage under a voltage.

3. Carrier of claim 2, composed of a plastic material, including polyethylene (PE); polyethylene terephthalate (PET); polypropylene (PP); polyvinylchloride (PVC); polyvinyl methacrylate (PVMA); polymethyl methacrylate (PMMA); polyamide (PA) or Nylon; polyetherketone (PEK); polytetrafluoroethylene (PTFE); polycarbonate (PC) or polyesters of carbonic acid; and copolymers thereof.

4. Carrier of claim 3, in the shape of a film, including a strip.

5. Carrier of claim 2, composed of an elastomer, including polybutadiene rubber (PBR); natural rubber (NR) i.e. 1-4 polyisoprene; chloroprene rubber (CR) i.e. polychloroprene; silicone rubbers, including methylvinylpolysiloxane (VMO); fluoroelastomers and copolymers thereof.

6. Carrier of claim 5, in the shape of a film, including a strip.

7. Carrier of claim 2, composed of a siliceous material, including quartz; quartz glass; glass; lead glass; steatite; calcareous rock, including travertine silicate; natural and synthetic crystals and stones.

8. Carrier of claim 2 in the shape of a grid.
